(19) United States
(12) Patent Application Publication
(10) Pub. No.: US 2012/0022937 A1
(43) Pub. Date: Jan. 26, 2012

(54) ADVERTISEMENT BRAND ENGAGEMENT VALUE

(75) Inventors: Tarun Bhatia, Simi Valley, CA (US); Darshan Kantak, Pasadena, CA (US); Chris Jaffe, Burlingame, CA (US); Eric Theodore Bax, Pasadena, CA (US); Ayman Farahat, San Francisco, CA (US)

(73) Assignee: Yahoo! Inc., Sunnyvale, CA (US)

(21) Appl. No.: 12/841,900

(22) Filed: Jul. 22, 2010

(51) Int. Cl. G06Q 30/00

(52) U.S. Cl. 705/14.41

(57) ABSTRACT

The present invention provides techniques associated with online advertisement brand engagement value, which can be of critical importance to brand advertisers. Techniques are also included involving use of brand engagement value across various online and offline advertising media and venues. Techniques are provided in which experiments are conducted, such as eyeball-tracking experiments, which include measurements to determine brand engagement value of particular online advertisement impressions. Information from the experiments is utilized in making determinations of brand engagement value, or anticipated brand engagement value, of online advertisement impressions for which brand engagement value has not been measured.

### BACKGROUND

Brand advertisers seek deep and lasting favorable engagement with their target audiences through advertising. In the past, such engagement value was usually sought through offline venues such as television and print. As audiences increasingly move online, online advertising is becoming increasingly important to brand advertisers, whether alone or in combination with offline advertising.

However, brand advertisers are generally not very clear on the brand engagement value provided by online advertising impressions. Typical tracked, measured, and priceable metrics, including metrics on which purchasing and pricing is typically based, such as impressions, click through rates and conversion rates, do not generally provide an accurate measure of brand engagement value of impressions. Even various other proxy measures, such as attributes of a user session, user interaction with Web site resources, or other interaction following exposure to an impression, do not generally provide an accurate measure of brand engagement. As just one example, a particularly engaging Wcb site may lead to heavy user interaction, including following exposure to an advertisement impression, yet this may not be accurately attributable to the advertisement impression.

Various types of impressions, serving contexts, target audiences, and advertising media and venues, both online and offline, can lead to different brand engagement value, yet brand advertisers are often hard-pressed to evaluate such value in connection with their advertising spend.

There is a need for brand engagement value-associated techniques in online and offline advertising.

### SUMMARY

Some embodiments of the invention provide techniques associated with online advertisement brand engagement value, which can be of critical importance to brand advertisers. Techniques are also included involving use of brand engagement value across various online and offline advertising media and venues. Techniques are provided in which experiments are conducted, such as biometric or eyeball-tracking experiments, which include measurements to determine brand engagement value or impact of particular online advertisement impressions and serving contexts. Information from the experiments is utilized in making determinations of brand engagement value, or anticipated brand engagement value, of online advertisement impressions for which brand engagement value has not been measured.

Some embodiments provide techniques in which a standardized or normalized unit of online advertisement brand engagement value is utilized, representing a specified amount of brand engagement value. The unit of brand engagement value can be used in expressing brand engagement value of past or anticipated online advertisement impressions, and in various aspects of advertising campaign operations and online advertising marketplace operations.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a flow diagram illustrating a method according to one embodiment of the invention;

FIG. 6 is a flow diagram illustrating a method according to one embodiment of the invention;

FIG. 7 is a flow diagram illustrating a method according to one embodiment of the invention;

FIG. 8 is a flow diagram illustrating a method according to one embodiment of the invention;

FIG. 9 is a flow diagram illustrating a method according to one embodiment of the invention;

FIG. 10 is a flow diagram illustrating a method according to one embodiment of the invention;

FIG. 11 is a flow diagram illustrating a method according to one embodiment of the invention; and

FIG. 12 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

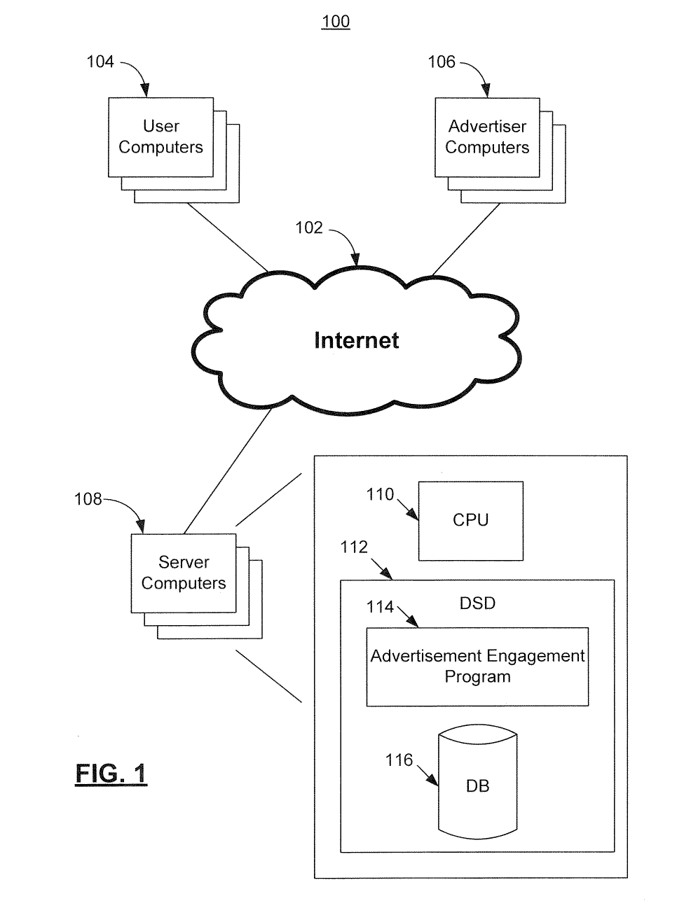

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and Advertisement Engagement Value Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

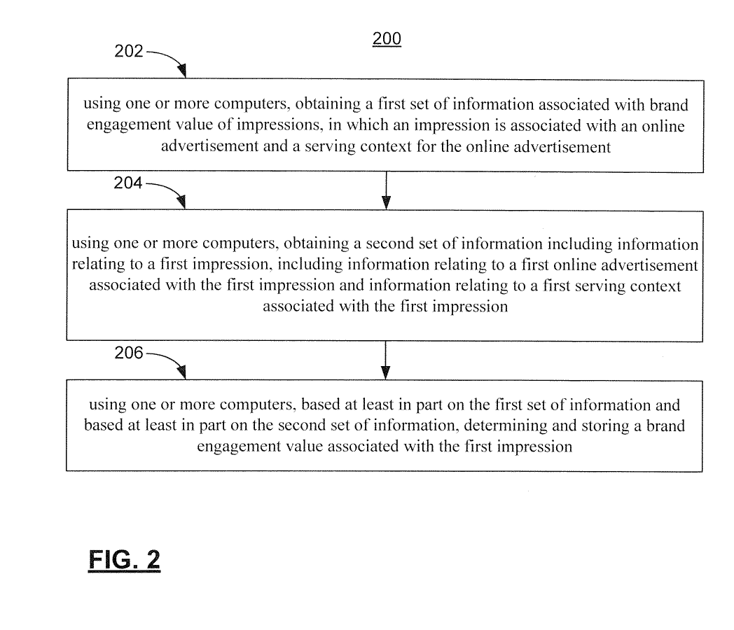

FIG. 2 is a flow diagram illustrating a method 200 according to one embodiment of the invention. At step 202, using one or more computers, a first set of information is obtained, associated with brand engagement value of impressions, in which an impression is associated with an online advertisement and a serving context for the online advertisement.

At step 204, using one or more computers, a second set of information is obtained, including information relating to a first impression, including information relating to a first online advertisement associated with the first impression and information relating to a first serving context associated with the first impression.

At step 206, using one or more computers, based at least in part on the first set of information and based at least in part on the second set of information, a brand engagement value is determined, associated with the first impression.

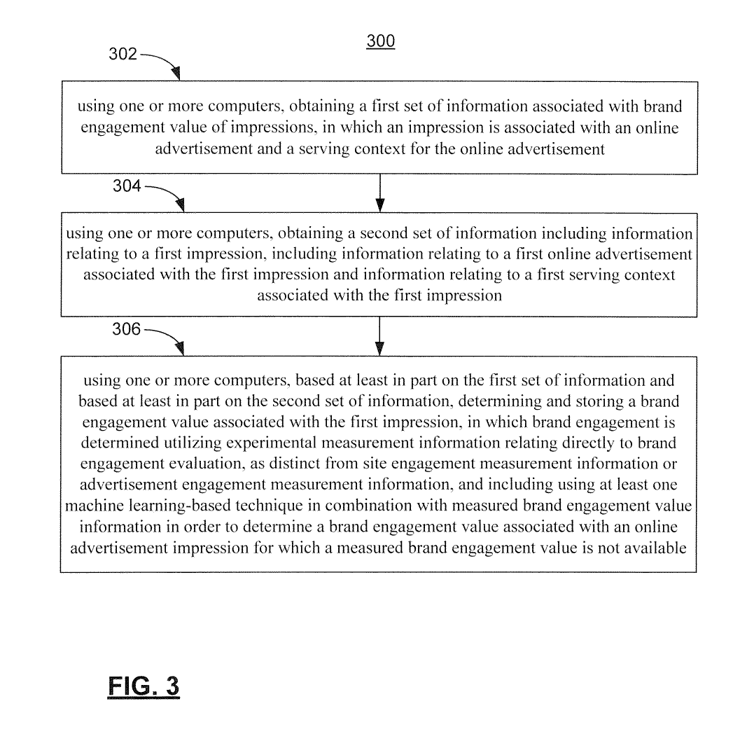

FIG. 3 is a flow diagram illustrating a method 300 according to one embodiment of the invention. At step 302, using one or more computers, a first set of information is obtained, associated with brand engagement value of impressions, in which an impression is associated an online advertisement and a serving context for the online advertisement.

At step 304, using one or more computers, a second set of information is obtained, including information relating to a first impression, including information relating to a first online advertisement associated with the first impression and information relating to a first serving context associated with the first impression.

At step 306, using one or more computers, based at least in part on the first set of information and based at least in part on the second set of information, a brand engagement value is determined and stored, associated with the first impression, in which brand engagement is determined utilizing experimental measurement information relating directly to brand engagement evaluation, as distinct from site engagement measurement information or advertisement engagement measurement information. The method 300 includes using at least one machine learning-based technique in combination with measured brand engagement value information in order to determine a brand engagement value associated with an online advertisement impression for which a measured brand engagement value is not available.

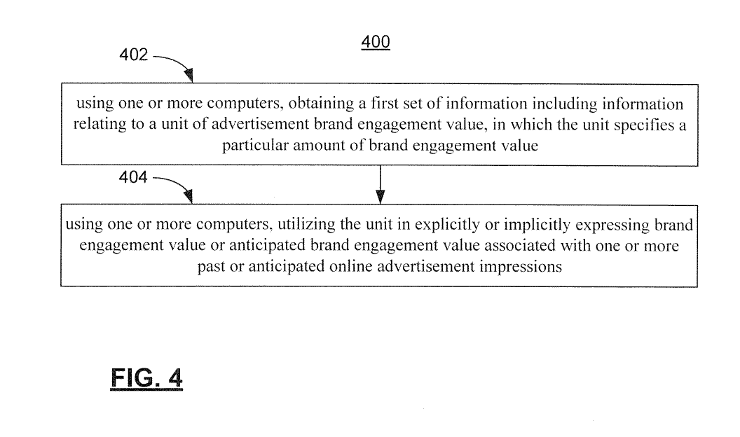

FIG. 4 is a flow diagram illustrating a method 400 according to one embodiment of the invention. At step 402, using one or more computers, a first set of information is obtained, including information relating to a unit of advertisement brand engagement value, in which the unit specifies a particular amount of brand engagement value.

At step 404, using one or more computers, the unit is utilized in explicitly or implicitly expressing brand engagement value or anticipated brand engagement value associated with one or more past or anticipated online advertisement impressions.

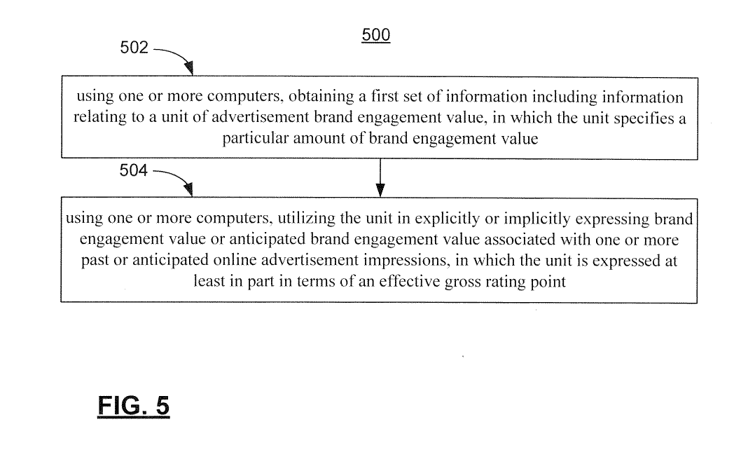

FIG. 5 is a flow diagram illustrating a method 500 according to one embodiment of the invention. At step 502, using one or more computers, a first set of information is obtained, including information relating to a unit of advertisement brand engagement value, in which the unit specifies a particular amount of brand engagement value.

At step 504, using one or more computers, the unit is utilized in explicitly or implicitly expressing brand engagement value or anticipated brand engagement value associated with one or more past or anticipated online advertisement impressions, in which the unit is expressed at least in part in terms of an effective gross rating point.

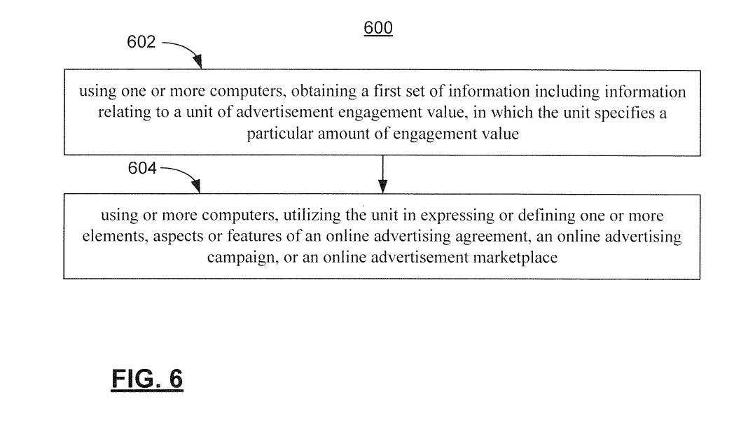

FIG. 6 is a flow diagram illustrating a method 600 according to one embodiment of the invention. At step 602, using one or more computers, a first set of information is obtained, including information relating to a unit of advertisement engagement value, in which the unit specifies a particular amount of engagement value.

At step 604, using or more computers, the unit is utilized in expressing or defining one or more elements, aspects or features of an online advertising agreement, an online advertising campaign, or an online advertisement marketplace.

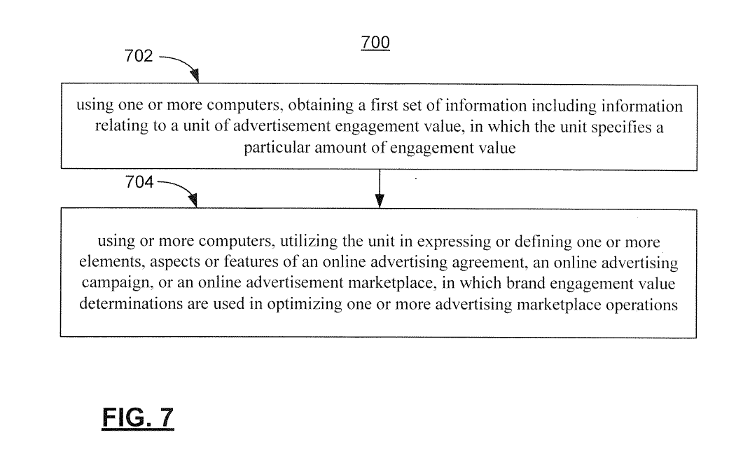

FIG. 7 is a flow diagram illustrating a method 700 according to one embodiment of the invention. At step 702, using one or more computers, a first set of information is obtained, including information relating to a unit of advertisement engagement value, in which the unit specifies a particular amount of engagement value.

At step 704, using one or more computers, the unit is utilized in expressing or defining one or more elements, aspects or features of an online advertising agreement, an online advertising campaign, or an online advertisement marketplace, in which brand engagement value determinations are used in optimizing one or more advertising marketplace operations.

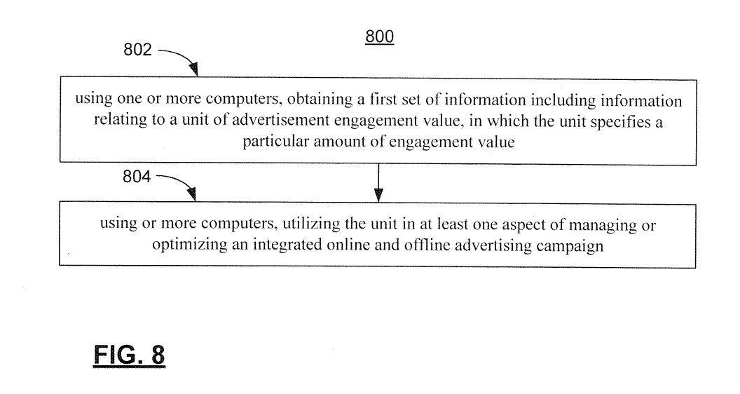

FIG. 8 is a flow diagram illustrating a method 800 according to one embodiment of the invention. At step 802, using one or more computers, a first set of information is obtained, including information relating to a unit of advertisement engagement value, in which the unit specifies a particular amount of engagement value.

At step 804, using or more computers, the unit is utilized in at least one aspect of managing or optimizing an integrated online and offline advertising campaign.

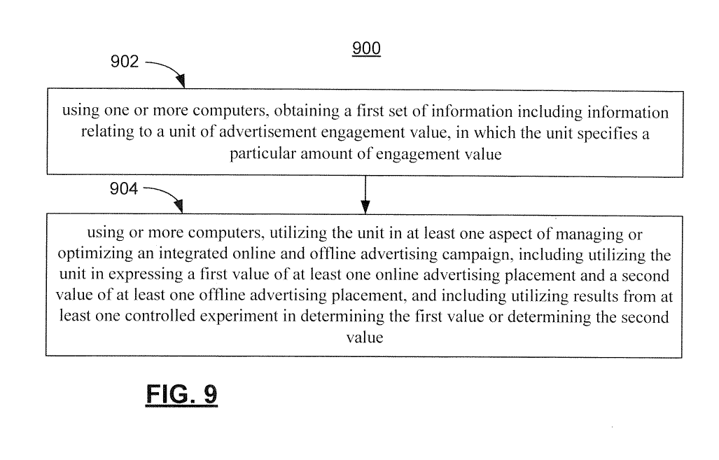

FIG. 9 is a flow diagram illustrating a method 900 according to one embodiment of the invention. At step 902, using one or more computers, a first set of information is obtained, including information relating to a unit of advertisement engagement value, in which the unit specifies a particular amount of engagement value.

At step 904, using or more computers, the unit is utilized in at least one aspect of managing or optimizing an integrated online and offline advertising campaign, comprising utilizing the unit in expressing a first value of at least one online advertising placement and a second value of at least one offline advertising placement, and comprising utilizing exults from at least one controlled experiment in determining the first value or determining the second value.

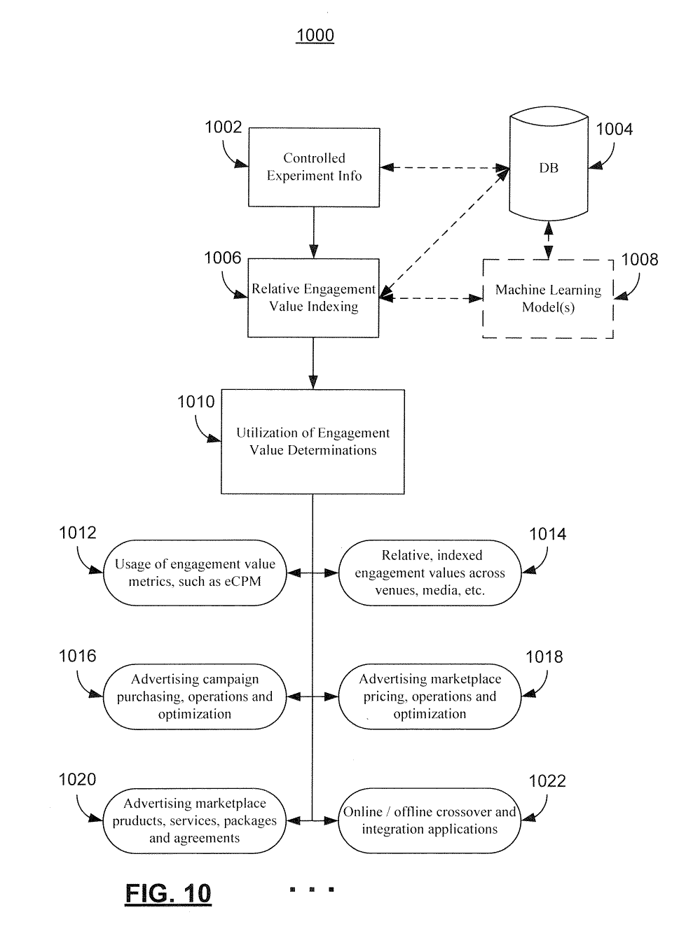

FIG. 10 is a flow diagram illustrating a method 1000 according to one embodiment of the invention. Step 1002 represents utilization of controlled experimentation information, which may be stored in one or more databases 1004.

Step 1006 represents relative engagement value indexing, such as according to various serving contexts, user clusters, venues, or media. The indexing may utilize one or more machine learning models 1008.

Step 1010 represents utilization of engagement value determinations for various purposes. For example, engagement value determinations can be used in connection with usage of engagement value metrics 1012, in connection with relative, indexed engagement values across venues, media, etc. 1014, in connection with advertising campaign purchasing, operations and optimization 1016, in connection with advertising marketplace pricing, operations and optimization 1018, in connection with advertising marketplace products, services, packages and agreements 1020 and offerings thereof, in connection with online/offline crossover and integration applications 1022, as well as in other ways.

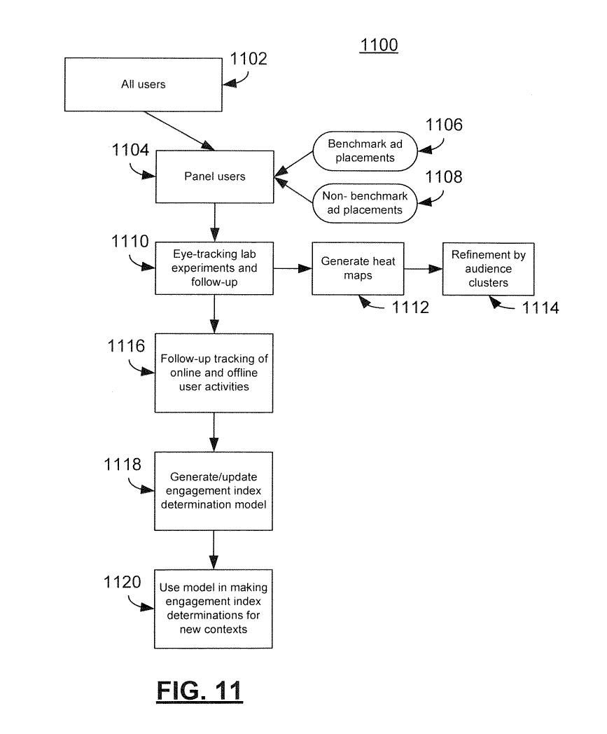

FIG. 11 is a flow diagram illustrating a method 1100 according to one embodiment of the invention. Step 1104 represents selection of a panel of users from all users 1102, for exposure to benchmark advertisement placements 1106 and non-benchmark advertisement placements 1108.

Step 1110 represents eye-tracking lab experiments and follow-up, including generation of heat maps 1112 and refinement of resulting information by determined audience clusters 1114.

Step 1116 represents follow-up tracking of online and offline user activities, such as online conversions, offline purchases, etc.

Step 1118 represents generation and/or updating of an engagement index determination model, which may be used for engagement value determinations in untested situations.

Step 1120 represents usage of the model in making engagement index determinations for new contexts.

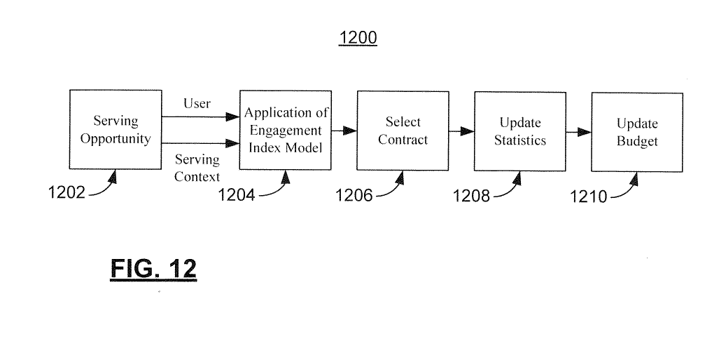

FIG. 12 is a block diagram 1200 illustrating one embodiment of the invention. Block 1202 represents a serving opportunity, including an associated user and serving context.

Block 1204 represents usage of an engagement index model in connection with the serving opportunity.

Block 1206 represents selection of an advertiser contract to be associated with an impression to be served in connection with the serving opportunity.

Block 1208 represents updating of statistics, such as in one or more databases, to represent allocation of the impression and its engagement value, in connection with satisfaction of the advertiser contract.

Block 1210 represents budget updating based on engagement value associated with the delivered impression.

Some embodiments of the invention provide methods to directly determine relative engagement value of advertisement impressions, across all advertising media, and across a diverse set of advertising placements within each medium (TV, print, banner advertisements, online advertising, etc.). An aim can be, for example, to provide reliable all-encompassing industry-wide metrics and benchmarks to aid efficient comparison for advertisement buying and pre-campaign counseling for advertisers and agencies, and to deliver marketplace efficiencies in allocation, especially for brand engagement-seeking advertisers.

In some embodiments, relative, direct engagement measures are sought, versus a reliable and stable benchmark, for efficient marketplace buying across the advertising industry, and for marketplace allocation of advertisement inventory to placements (online or offline).

Some embodiments provide methods for calibration of a stable and reliable industry-wide benchmark and indexing based on eye-tracking studies as one potential signal. The benchmark could cover placements across media types from various industry providers.

Some embodiments provide techniques including application of engagement values assessed to relatively index various media channels, for instance, digital advertising versus TV, print, and banner advertisements, and the advertisement contexts therein, for instance, to enable efficient marketing dollar allocation for marketing professionals.

Some embodiments provide methods to allow insights to be developed across various dimensions, and the states within. Examples include medium, such as offline (TV, print, banner) or online; site/context, such as finance page from Google, AOL Microsoft, or Yahoo; placement, including online advertisement units on various sites such as LREC, MON, or SKY, or a bus-stop display advertisement versus a large highway banner advertisement; the advertisement format, such as video or display advertisements, including a 30 second TV spot, a text advertisement, or an online 15 second video advertisement; the time of day, such as day parts, or specific to events like after-market hours; geographic locations; and user's emotional state or contcnt's emotional classification, such as engagement when a user is mapped to “happy” versus “elated” state, etc.

Some embodiments include providing the notion of an effective Gross Rating Point (e-GRP), or something similar, for assessing the GRP delivered by diverse placements that come from across various media (offline or online advertising).

Some embodiments include providing support for new engagement-based advertising products, such as cost per engagement (CPE) model where the engagement is that associated with the placement and advertisement, and not necessarily related to some subsequent user action or interaction event, such as a click, thumbs-up, etc.

Some embodiments include providing performance feedback and closed loop campaign optimization. For example, in some embodiments, to support go-to-market and adoption of engagement measurements, performance assessment is provided with support for standard and custom tailored brand lift metrics that tie back to the engagement level delivered through impressions, in helping advertisers focused on brand engagement to find efficient channels and placements for advertising their brand.

Some embodiments include the incorporation of custom brand lift metrics suited to the advertiser in determining what is efficient engagement-delivering campaign spend.

Some embodiments include providing methods that lend themselves to refinement along any targeting criteria (those currently offered in the market, and to be offered, such as emotional targeting) to enable campaign optimization for advertisers seeking engagement.

Some embodiments include providing advertising campaign pre-sale support. For example, some embodiments include enabling pre-campaign planning to guide advertising buys across any industry media and placement from any vendor. This can include offline and online.

Some embodiments include the employment of such benchmark and indexing in delivering marketplace efficiencies in advertising inventory allocation, be it for online advertising via auctions or other mechanisms for offline advertisement selection mechanisms for placements.

Some embodiments include aspects relating to pricing and allocation. For example, some embodiments include the ability to set prices and allocate inventory adjusting for engagement value or engagement capacity of placement opportunity specific to eligible advertisements.

Some embodiments recognize that once engagement of an impression is measurable, it can be employed, among other things, in making efficient allocation of online advertisement inventory to engagement-seeking brand advertisers, in packaging engagement products more directly for advertisers, and in informing advertisers of the level of brand engagement delivered by a campaign, as opposed to burdening them with this estimation on their own with an incomplete or proxy information source. This, in turn, can, for example, help marketing professionals at the advertising agencies and companies to make informed decisions in allocating marketing dollars effectively to deliver high ROI engagement across all venues that touch their target audience.

Some embodiments, for example, (a) define a standard relative unit of engagement delivered by an online impression, (b) propose a calibration methodology for relative engagement value of online advertisement impressions, (c) provide techniques for its employment in delivering marketplace efficiencies when allocating online advertisements to opportunities to serve, (d) provide new engagement-based advertising products, such as directly buying engagement and feedback on engagement delivered, and (e) provide for the relative benchmarking of online advertising and offline advertising media (TV, print, banner, etc.) to help generate the relative value of their engagement capacity.

Some embodiments include a recognition that impressions differ in engagement value. Not all impressions are alike in their ability to engage with an audience. Typically, brand advertisers buy online impressions without any marketplace guidance to discern valuable impressions. In other words, advertisers often must determine and specify what they value and for how much, and the marketplace then delivers on expressed demand. What brand advertisers typically really seek is engagement, but for the lack of a direct measure offered by the marketplace, they are often forced to assess this value on their own and buy impressions. This can lead to inefficient learning and matching in the marketplace.

Some embodiments include a recognition that viewership is not necessarily advertisement engagement. Attributes of the user session and inter-activity with Web site resources (content and services) are no doubt valuable signals, but not necessarily relevant for engagement from an advertiser's perspective. For example, an engaging Web site may steal attention away from advertisements that appear on it. What an advertiser may be interested in is the engagement that their creatives are likely to receive in specific online advertising contexts, because that is what brand advertisers may really seek from their campaigns.

Some embodiments include a recognition that the market lacks an advertiser-centric definition of engagement to aide in efficient buying and selling of online advertisement inventory. Some embodiments effectively provide a brand engagement definition which can aid in standardization of inventory, creating the conditions for a more efficient engagement marketplace.

Some embodiments recognize that it is not trivial to estimate engagement that an advertisement impression will receive, during the advertisement selection process to serve an advertisement to an online advertising opportunity. Specifically, determining, for example, whether a brand gains more or less notice and impact, or positive impact, from the current impression opportunity, and across various advertisement positions and contexts, can be difficult. It is much easier to approximate advertisement engagement based on other related measures such as site viewership, or the predicted click-through rate, but this is not entirely accurate. For instance, annoying advertisements can trick clicks and appear engaging, but brand advertisers go to lengths to avoid such placements.

Some embodiments provide techniques for attributing engagement to advertisement impressions. Some embodiments include a recognition that it is easier to measure subsequent (post-impression) observations of online user activities as a proxy for engagement. Observations include, for instance, searches for the brand, clicks leading to the advertiser's website, interactions with the advertisement (such as closing the advertisement, sharing with friends, playing or not interrupting the advertisement, etc.). However, it is still quite hard to attribute these events to advertisement impressions that preceded them. Other factors, such as a TV or banner advertisement campaigns, could promote these as well.

Some embodiments include a recognition that impressions can have inherent value, otherwise brand advertisers would not be buying them (as in CPM campaigns). For example, direct engagement can be considered, in some embodiments, as the engagement an advertisement impression generates as it is impressed for the user in an advertisement unit (advertisement context). Then, estimating direct engagement for an impression could seek the weight of an impression in terms of favorably engaging with the user. For instance, the question may be asked, how likely is an advertisement impression to be noticed and favorably associated or remembered as a result of its placement across various potential advertisement placements (contexts)? Note that this does not depend on subsequent action such as clicks or searches, although they could be studied for correlation, and used as a proxy when such information is absent.

Some embodiments include a recognition that it may not be practical to measure at scale the direct engagement an impression commands, outside of observing subsequent events that could be correlated (but potentially not caused) by advertisement impressions. This approach could also run the risk of devaluing impressions that do not result in any subsequent observations, either due to a limited scope of observations or the inability to observe them.

Some embodiments include evaluating relative engagement of online and offline media channels, and advertisement contexts. Some embodiments include a recognition that it is hard to compare the relative engaging capacity of value to a brand from advertising across diverse channels such as TV, newspaper, or banner advertisements, versus online advertising. This can impede adoption of online advertising and can throttle the migration of marketing funds from offline venues to online.

Some embodiments include providing a solution including measuring direct engagement through eye-tracking experiments across a panel of users. Then, machine learning models can be used to project panel learnings to the complementary space of users not in the panel. Although eye-tracking experiments are primarily discussed, many other methods and experimental techniques and parameters are contemplated by embodiments of the invention. For example, in some embodiments, various biometric techniques may be utilized in connection with engagement assessment or measurement, and various biometric parameters or combinations of parameters may be monitored, measured or utilized.

Some embodiments provide a definition of direct engagement for an advertisement or brand. In some embodiments, this metric promotes relative value assessments, or may provide absolute measures of engagement.

Furthermore, some embodiments provide a practical approach for measuring and calibrating inventory placements on advertisement engagement.

Some embodiments include techniques for using the engagement metric and its measurement in tuning marketplace allocation of online advertisement inventory to campaigns, essentially creating an online marketplace for engagement.

Some embodiments provide, using the engagement metric and its measurement, new advertising products that package a certain amount of engagement directly for advertisers, rather than forcing them to buy impressions.

Some embodiments provide an approach that scales effectively across all marketplace transactions, and supports the classification of inventory in terms of its engagement value for a brand, as well as the selling and pricing of guaranteed and non-guaranteed campaigns that seek direct engagement, and not some subsequent user activity.

Some embodiments provide a benchmark, for the purpose of relative value assessment. Refinement may be used when a single benchmark is insufficient to allocate efficiently. Refinement could be, for example, along the dimensions of specific content verticals, industry verticals, audience segments, and even custom for brands.

Some embodiments provide relative benchmarking to TV, print, banner, and other offline media. In some embodiments, to enable comparison of engagement capacity of various advertising media available to advertisers, methodology is extended to incorporate these media and calibrate the online index relative to these offline media channels. This can enable advertising customers to determine the allocation of funds relative to engagement efficiencies delivered.

Some embodiments include a recognition that, while gross rating points (GRP) is used primarily for offline media, as a metric that indicates an effective engagement with a target audience, there are some issues with this. For one, GRP's are counted for runs of an advertisement, say during a TV show that appeals to a targeted demographic, with no feedback on how many actually saw the show or the advertisement. The audience could have missed the show, missed the advertisement, or explicitly skipped the advertisement by stepping out during the break, or forwarding past it on replay. In online versions, user inputs strictly define which advertisement impressions are successful or not, and an it is a more reliable delivery medium. Some embodiments provide a unifying notion that helps contrast the effective-GRP (eGRP) delivered online for various advertisement formats and advertisement contexts that help advertisers allocate funds efficiently. An effective GRP can help normalize the engagement delivered to a target audience population for a given media buy, regardless of the channel or venue, i.e., one TV show versus another, an online advertisement unit versus a TV show, an online advertisement unit versus a newspaper print advertisement, etc. This can be important, because it can encompass all media and is in terms familiar to advertising functions.

Some embodiments present a methodology for estimating the engagement value of online advertisement impressions. It begins with the definition of a benchmark of online placements (advertisement units), that appear across various properties, advertisement unit sizes, and advertisement unit types. These may be referred to as online advertisement contexts. Next, a set of carefully selected online users are drafted into a panel that will be invited to a specially equipped lab. Care is taken in designing the panel such that it is representative of the online population of users that will arrive in the marketplace for online advertisements. The panel is to be fairly randomized.

In some embodiments, users in the panel are then shown variety of advertisements on placements that are both in, and not in, the benchmark set of advertisement placements. Using special eye-tracking equipment, heat maps are generated for each user and analyzed later for engagement with the page, and the advertisement and its placement. In addition, subsequent user activities are also tracked from both online (clicks on advertisements, searches performed, items purchased, landing pages visited, conversions, etc.) and offline (purchases in stores, advertisements noticed, etc.) realms.

In some embodiments, heat maps represent, for example, the engagement intensity received by different areas on the page. Heat map data for all panel users, across benchmark and non-benchmark properties, are analyzed to determine the engagement of non-benchmark placements relative those in the benchmark. This can be equivalent, for example, to coming up with a relative weight for all placements, to a benchmark that represents a standard engagement.

In some embodiments, the selection of the benchmark could be criteria driven. For instance, the top 20% contexts in terms of heat map-indicated engagement could be considered to be in the benchmark. Care is to be taken in any event to reduce the variability in the benchmark, and for the benchmark to represent fairly standard performance from an engagement perspective. An absolute measure of engagement could then be the amount of engagement delivered by 1,000 impressions to a standard benchmark advertisement (such as a house advertisement) on benchmark properties, for example.

Furthermore, a relative engagement index E(c) for any advertisement context c, could be the engagement delivered in advertisement context c relative to the same advertisement on the benchmark set of advertisement units. For contexts in the benchmark, this is 1 by definition.

In some embodiments, the form can can be used:

□(c)=E(c)/E(Benchmark) Eq. (1)

E(c):H(heatmap(c)) [symbol] E(C)εR Eq. (2)

In the above, E(c) is the result of a functional transformation (H) of the heat map profile data of an advertisement context (c), to a numerical value. This means that E(c)ε[0, 1] for contexts that are inferior to the benchmark, and >1 for contexts superior to the benchmark. Alternately, the benchmark could be selected as the top properties, which would result in Eε[0, 1].

Further, the □ calibration could be refined across audience segments, across industry verticals, across content verticals, or for specific advertising brands as a custom service. This would result in several □ curves, such as □(c,u) where u represents some classification of users (on any criteria), and c is some class of context refinement.

Panel users could also be tracked for subsequent online and offline events related to various brands. Their activities could be analyzed along with eye-tracked heat map data to create a model for engagement as a function of other observable post-impression events.

□(pane) [symbol] F(clicks,searches,user attributes) Eq. (3)

Such a model (say F) would be tuned based on panel users, but could be applied to non-panel users, for which eye-tracking data is not available or practical. Clustering of panel users on post-impression activity could help identify meaningful segments of users that help refine engagement indices further.

Panel users could be subjected to advertisements from various contexts within several mediums (including offline media such as TV, print, and banner) and relative comparisons could be created of the various advertising options in terms of their effective engagement, on the familiar and well known GRP metric, through the effective GRP (eGRP).

In some embodiments, data collected from users in the panel (for benchmark and non-benchmark contexts) serves to calibrate relative engagement delivered by each context. This provides basis for engagement indexing the non-benchmark contexts.

In some embodiments, refined engagement indices can be generated for various audience segments from the above data.

Users not in the panel can be classified to a user segment and use the associated engagement index profile for relative assessment of contexts (benchmark and non-benchmark) and their engagement.

New users can be incorporated in the classification scheme, using known attribute values of the users.

New contexts can similarly be classified to existing contexts (like-context) using classification.

In some embodiments, controlled experiments are used to measure the marginal outcomes (clicks, conversions, offline, brand recognition/affinity). In other words, for example, to correct for outside influences by also having panel users that are not shown the test advertisements, and by comparing outcomes.

In some embodiments, with the above computations in place, as a user visits a Web page and generates an opportunity to serve an advertisement, an engagement index is looked up corresponding to the user and advertisement context. Given this information, the advertisement selection process looks for those advertisements that are likely to get the highest value from engagement in this context. The index can be refined specific to the industry vertical and specific brands. The matching campaigns can be ranked considering the engagement value of the matched advertisement and context. The most efficient match (that generates the highest value for advertiser, and hence publisher, for example) gets promoted to be impressed.

In some embodiments, when an advertisement is impressed once, the delivery statistics that record delivered engagement account for the final engagement index value used, and update the engagement delivered. So, an impression with an engagement index value of 0.5 can end up counted as 1 impression, but only 0.5 units of engagement (relative to the benchmark).

In some embodiments, similarly, budgets are consumed considering discounts for poorly engaging impressions in the proportion of the engagement index value. As a result, more impressions could be shown to make up for a certain level of engagement that is expected.

In some embodiments, with the above provisions, various offerings can be made available to the marketplace. For example, in some embodiments, advertisers buy some guaranteed units of engagement, and as many impressions are delivered across feasible contexts as needed to fulfill that engagement guarantee. As another example, advertisers may continue to buy guaranteed number impressions as before, but are informed of the units of engagement delivered for their campaigns. As another example, as a result of differentiation and refinement of value of impressions to brand advertisers, CPM campaigns can be adjusted with the engagement indices and submitted as bids for any online serve-time allocation scheme for online advertisement inventory. As another example, in non-guaranteed marketplaces, advertisers, bids can be automatically adjusted for brand engagement-seeking advertisers, without the need to manage their bids in response to engagement delivered in various contexts. As another example, as a result of efficient bidding, advertiser budgets would be utilized in relation with the value delivered.

In some embodiments, as a result of eliminating the need for advertisers to determine and buy high-engaging buys, engagement buying can be made worry-free, in some sense. The result is a greater and less-constrained, more efficient expression of advertising demand from advertisers. This ultimately delivers marketplace efficiencies because of greater coverage and competition.

In some embodiments, by showing panel users advertisements in various contexts across all advertising media (TV, print, banner, online etc.), methods can be provided that enable calibration of the relative engagement capacity of various media buys that an advertising function must allocate funds across. The utility derived from each can be analytically and scientifically assessed, and can drive the flow of funds towards the most efficient media from an advertiser's engagement point of view.

In some embodiments, doing all of the above can enable usage of a well adopted and familiar metric that is already embedded in the marketing budget allocation process of most companies, and extend it to incorporate online advertising. This can accelerate adoption of online advertising, especially in areas where it offers unique efficiencies.

Furthermore, in some embodiments, all the above provisions can be implemented in both the guaranteed and non-guaranteed marketplaces. In some embodiments, CPM values will reflect adjustments for engagement index and will b submitted into the existing eCPM framework for ranking and pricing.

While the invention is described with reference to the above drawings, the drawings are intended to be illustrative, and the invention contemplates other embodiments within the spirit of the invention.

1. A method comprising:
using one or more computers, obtaining a first set of information associated with brand engagement value of impressions, wherein an impression is associated with an online advertisement and a serving context for the online advertisement;
using one or more computers, obtaining a second set of information comprising information relating to a first impression, including information relating to a first online advertisement associated with the first impression and information relating to a first serving context associated with the first impression; and
using one or more computers, based at least in part on the first set of information and based at least in part on the second set of information, determining and storing a brand engagement value associated with the first impression.

2. The method of claim 1, wherein the first set of information is used in evaluating brand engagement value of online advertisement impressions.

3. The method of claim 1, wherein determining a brand engagement value comprises determining an estimated, anticipated, forecasted, or predicted brand engagement value.

4. The method of claim 1, comprising obtaining a first set of information associated with brand engagement value of impressions, wherein brand engagement value provides an indication of a degree of favorable engagement of a user relating to a brand associated with an online advertisement.

5. The method of claim 1, comprising obtaining a first set of information associated with brand engagement value of impressions, wherein brand engagement value is measured in absolute terms.

6. The method of claim 1, comprising obtaining a first set of information associated with brand engagement value of impressions, wherein brand engagement value is measured in relative terms.

7. The method of claim 1, comprising obtaining a first set of information associated with brand engagement value of impressions, wherein measurement of engagement value includes utilization of at least one biometric technique.

8. The method of claim 1, comprising obtaining a first set of information associated with brand engagement value of impressions, wherein measurement of engagement value includes utilization of eye-tracking experimentation.

9. The method of claim 1, comprising obtaining a first set of information associated with brand engagement value of impressions, wherein an impression is associated with an online advertisement and a serving context for the online advertisement, and wherein the a serving context includes a user receiving an impression.

10. The method of claim 1, comprising obtaining a first set of information associated with brand engagement value of impressions, wherein the first set of information comprises benchmark information relating to measured engagement value for a set of advertisement impressions.

11. The method of claim 1, comprising obtaining a first set of information associated with brand engagement value of impressions, wherein the first set of information comprises benchmark information relating to measured engagement value for a set of advertisement impressions served to a selected panel of users.

12. The method of claim 1, comprising obtaining a first set of information associated with brand engagement value of impressions, wherein the first set of information comprises benchmark information relating to measured engagement value for a set of advertisement impressions served to a selected panel of users, obtained through one or more controlled experiments.

13. The method of claim 1, comprising obtaining a first set of information associated with brand engagement value of impressions, wherein the first set of information comprises benchmark information relating to measured engagement value for a set of advertisement impressions served to a selected panel of users, obtained at least in part using one or more eyeball-tracking experiments.

14. The method of claim 1, comprising obtaining a first set of information associated with brand engagement value of impressions, wherein the first set of information comprises benchmark information relating to measured engagement value for a set of advertisement impressions served to a selected panel of users, and comprising using at least one machine learning-based technique in combination with measured brand engagement value information in order to determine a brand engagement value associated with an online advertisement impression for which a measured brand engagement value is not available.

15. The method of claim 1, wherein brand engagement value is directly evaluated, as distinct from site engagement or advertisement engagement.

16. The method of claim 1, wherein brand engagement is determined utilizing experimental measurement information relating directly to brand engagement evaluation, as distinct from site engagement measurement information or advertisement engagement measurement information.

17. The method of claim 1, wherein brand engagement value is indexed based on aspects of the serving context.

18. A system comprising:
one or more server computers coupled to a network; and
one or more databases coupled to the one or more server computers;
wherein the one or more server computers are for:
obtaining a first set of information associated with brand engagement value of impressions, wherein an impression is associated with an online advertisement and a serving context for the online advertisement;
obtaining a second set of information comprising information relating to a first impression, including information relating to a first online advertisement associated with the first impression and information relating to a first serving context associated with the first impression; and
based at least in part on the first set of information and based at least in part on the second set of information, determining and storing, in at least one of the one or more databases, a brand engagement value associated with the first impression.

19. The system of claim 18, wherein at least one or more or more servers are coupled to a database.

20. The system of claim 18, wherein brand engagement is determined utilizing experimental measurement information relating directly to brand engagement evaluation, as distinct from site engagement measurement information or advertisement engagement measurement information.

21. The system of claim 18, comprising using at least one machine learning-based technique in combination with measured brand engagement value information in order to determine a brand engagement value associated with an online advertisement impression for which a measured brand engagement value is not available.

22. A computer readable medium or media containing instructions for executing a method comprising:
using one or more computers, obtaining a first set of information associated with brand engagement value of impressions, wherein an impression is associated with an online advertisement and a serving context for the online advertisement;
using one or more computers, obtaining a second set of information comprising information relating to a first impression, including information relating to a first online advertisement associated with the first impression and information relating to a first serving context associated with the first impression; and
using one or more computers, based at least in part on the first set of information and based at least in part on the second set of information, determining and storing a brand engagement value associated with the first impression;
wherein brand engagement is determined utilizing experimental measurement information relating directly to brand engagement evaluation, as distinct from site engagement measurement information or advertisement engagement measurement information; and
comprising using at least one machine learning-based technique in combination with measured brand engagement value information in order to determine a brand engagement value associated with an online advertisement impression for which a measured brand engagement value not available.
